(19) United States
(12) Patent Application Publication
(10) Pub. No.: US 2014/0254171 A1
(43) Pub. Date: Sep. 11, 2014

(54) LIGHTING APPARATUS

(71) Applicant: KONINKLIJKE PHILIPS N.V., EINDHOVEN (NL)

(72) Inventor: Horst Greiner, Aachen (DE)

(73) Assignee: KONINKLIJKE PHILIPS N.V., EINDHOVEN (NL)

(21) Appl. No.: 14/350,410

(22) PCT Filed: Sep. 26, 2012
(86) PCT No.: PCT/IB2012/055114

§ 371 Date: Apr. 8, 2014

Related U.S. Application Data
(60) Provisional application No. 61/545,776, filed on Oct. 11, 2011.

(51) Int. Cl. F21V 8/00

(52) U.S. Cl. CPC G02B 6/0073; G02B 6/0031
USPC 362/308; 362/311.02; 29/592.1

(57) ABSTRACT

The invention relates to alighting apparatus comprising a light emission unit (2) for emitting light (3) from an emission surface (4) in a main emission direction (6), and an outcoupling unit (7) for coupling the light out of the light emission unit. The outcoupling unit comprises a first surface (8) having a first central region (9) optically coupled to the emission surface and a first peripheral region (10) enclosing the first central region, and a second surface (11) opposite to the first surface. The peripheral regions can be structured, wherein the ratio of a) the area of the emission surface to b) the area of the first surface or the second surface is smaller than 0.5. This configuration can significantly decrease the likelihood of reabsorption of light by the emission surface, thereby increasing the efficiency of extracting light out of the lighting apparatus.

### FIELD OF THE INVENTION

The invention relates to a lighting apparatus, a lighting system comprising a group of the lighting apparatuses and a production method for producing the lighting apparatus.

### BACKGROUND OF THE INVENTION

US 20090278448 A1 discloses a luminous panel comprising a transparent flat substrate having an edge face, two main faces and a given thickness. The luminous panel further comprises at least one direct light region defined by a light source associated with one of the main faces, and a visible and/or ultraviolet radiation source producing radiation which is guided by total reflections in the thickness of the substrate. The luminous panel includes at least one extraction zone for extracting the guided radiation, wherein the extraction zone is associated with one of the main faces in order to form another luminous region separate from the direct light region. On the side of the main face associated with the extraction zone the direct light region has a lower luminance then the luminance of the other luminous region. A significant part of the radiation produced by the visible and/or ultraviolet radiation source is not extracted out of the luminous panel and does not illuminate the surrounding, i.e. the extraction efficiency is reduced.

### SUMMARY OF THE INVENTION

It is an object of the present invention to provide a lighting apparatus having an increased efficiency of extracting light out of the lighting apparatus. It is a further object of the present invention to provide a lighting system comprising several of the lighting apparatuses and a production method for producing the lighting apparatus.

In a first aspect of the present invention a lighting apparatus is presented, wherein the lighting apparatus comprises:
a light emission unit for emitting light from an emission surface in a main emission direction,
an outcoupling unit for coupling the light out of the light emission unit, wherein the outcoupling unit comprises:
   a first surface having a first central region optically coupled to the emission surface of the light emission unit and a first peripheral region enclosing the first central region,
   a second surface being opposite to the first surface in the main emission direction, the second surface having a second central region, which is opposite to the first central region, and a second peripheral region, which is opposite to the first peripheral region and which encloses the second central region, wherein at least one of the first peripheral region, the second peripheral region and an intermediate region between the first and second peripheral regions is structured and wherein the ratio of a) the area of the emission surface of the light emission unit to b) the area of the first surface or the second surface of the outcoupling unit is smaller than 0.5.

It has been found that, if at least one of the first peripheral region, the second peripheral region and the intermediate region between the first and the second peripheral regions is structured, wherein the ratio of a) the area of the emission surface of the light emission unit, which is optically coupled to the first central region of the first surface, to b) the area of the first surface or of the second surface of the outcoupling unit is smaller than 0.5, the likelihood of a reabsorption of light emitted by the emission surface of the light emission unit by the emission surface can be significantly decreased, thereby increasing the efficiency of extracting light out of the lighting apparatus.

The first and second surfaces are substantially parallel to each other and substantially perpendicular to the main emission direction. For instance, the outcoupling unit can be a light-guide plate, wherein the first and second surfaces are formed by two opposing sides of the light-guide plate.

The main emission direction is preferentially perpendicular to the emission surface. It can be the average direction in which the light emitted by the light emission unit leaves the light emission unit.

At least one of the first and second central regions is preferentially circular or rectangular. However, the first and/or second central region can also have another shape. The enclosing respective first and second peripheral regions can be shaped in accordance with the first and second central regions, respectively, or they can have another shape.

The lighting apparatus is preferentially a luminaire, and the light emission unit is preferentially an organic light emitting diode (OLED). It has been found that the outcoupling unit is particularly efficient, if the outcoupling unit is used for extracting light out of an OLED.

In an embodiment, the OLED is a bottom emitting OLED having an emission surface, through which the light leaves the OLED, at the bottom of the OLED. In another embodiment, the OLED is a top emitting OLED having an emission surface, through which the light leaves the OLED, at the top of the OLED.

The outcoupling unit comprises preferentially a transparent material like glass or PMMA. The outcoupling unit is, for example, a light-guide plate made of a transparent material, wherein the OLED can be optically coupled to the first central region of the first surface by using, for instance, a transparent adhesive. The OLED comprises preferentially a substrate, on which several organic light emitting layers, an anode and a cathode are arranged, wherein the substrate can be a separate element, i.e. the substrate and the outcoupling unit can be two elements that are optically coupled to each other, or the substrate and the outcoupling unit can form a single integrated element. If a transparent adhesive is used for optically coupling the first central region of the first surface of the light-guide plate with the substrate of the OLED, the transparent adhesive preferentially matches the refractive index of the light-guide plate and the OLED substrate.

The outcoupling unit can be a light-guide plate having a thickness within a range of, for example, about 1.5 to 2.0 cm. Moreover, it can be, for example, circular with a diameter of about 16 cm, wherein the emission surface can also be circular and have a diameter of, for instance, about 6 cm, or the light-guide plate can have a square shape with a side length of about 20 cm, wherein the emission surface can also have a square shape with a side length of, for instance, about 5 cm.

It is further preferred that a dimension of the outcoupling unit in the main emission direction is larger than a fifth of the length of a shortest line, which connects two opposing parts of the perimeter of the emission surface and traverses the center of the emission surface. That means, several imaginary lines can be present, wherein each of these lines connects two opposing parts of the perimeter of the emission surface and traverses the center of the emission surface and wherein the dimension of the outcoupling unit in the main emission direction is larger than a fifth of the length of the shortest one of these lines. In particular, the light emission surface can be circular and the dimension of the outcoupling unit in the main emission direction can be larger than a fifth of the diameter of the light emission surface. Moreover, the outcoupling unit can be a light-guide plate and the dimension in the main emission direction can be the thickness of the light-guide plate.

It has been found that, if the dimension of the outcoupling unit in the main emission direction is larger than a fifth of the diameter of the light emission surface, the likelihood of a reabsorption of light emitted by the light emission unit is significantly decreased and, thus, the extraction efficiency is significantly increased, although the outcoupling unit is relatively flat. It is therefore possible to provide a relatively flat lighting apparatus with increased extraction efficiency.

It is further preferred that a dimension of the outcoupling unit in the main emission direction is smaller than a half of the length of a shortest line connecting two opposing parts of the perimeter of the emission surface and traversing the center of the emission surface. That means, several imaginary lines can be present, wherein each of these lines connects two opposing parts of the perimeter of the emission surface and traverses the center of the emission surface and wherein the dimension of the outcoupling unit in the main emission direction is smaller than a half of the length of the shortest one of these lines. In particular, the light emission surface can be circular and the dimension of the outcoupling unit in the main emission direction, which is preferentially the thickness of a light-guide plate which may form the outcoupling unit, can be smaller than a half of the diameter of the light emission surface. It has been found that a larger outcoupling unit, in particular, a light-guide plate having a larger thickness, may not lead to a significant further reduction of reabsorption of light at the light emission surface and may therefore only increase the bulkiness of the lighting apparatus, without significantly increasing the extraction efficiency. A relatively flat outcoupling unit, which provides an increased extraction efficiency, can therefore be provided.

It is also preferred that the second central region is larger than the first central region. In particular, the dimensions of the outcoupling unit define an outcoupling angular range defined by total internal reflection, wherein rays of the emitted light enclosing an emission angle with the main emission direction, which is outside of the outcoupling angular range, would be totally reflected on the inner second surface, if the inner second surface would be planar, wherein the second central region is planar and dimensioned such that all rays within the outcoupling angular range meet the second central region.

Thus, rays within the outcoupling angular range, which defines an “escape cone”, are not totally reflected, but can leave the outcoupling unit through the second central region, whereas rays outside of the outcoupling angular range are propagated to the first peripheral region, the second peripheral region and the intermediate region between the first and second peripheral regions, wherein these rays may leave the outcoupling unit through at least one of the first and second peripheral regions, in particular, by scattering at the structures in these regions.

In an embodiment, the first peripheral region is larger than the second peripheral region. In a further embodiment, one of the first peripheral region and the second peripheral region is planar and the other of the first peripheral region and the second peripheral region is structured, in particular, in order to scatter light. In another embodiment the first peripheral region and the second peripheral region are structured, in particular, differently structured. By structuring at least one of the first and second peripheral regions, escape regions can be defined, at which the light, which has been internally totally reflected at the second central region, predominantly leaves the outcoupling unit. There is therefore a plurality of different possibilities of structuring the outcoupling unit, which provides a large versatility in producing a desired illumination.

The structuring can be provided by at least one of refractive and scattering structures. The structures can be, for example, 1 mm or smaller. In particular, they can be in the range of 10 to 100 μm. They can be microstructures, for instance, microlenses. The structures can also be, for examples, spherical or prismatic structures. They can be formed as indentations in the outcoupling unit.

In an embodiment, the lighting apparatus comprises several light emission units with several emission surfaces emitting light in the main emission direction, wherein the first surface comprises several first central regions optically coupled to the several emission surfaces and several first peripheral regions enclosing the first central regions, wherein the second surface comprises several second central regions being each opposite to a respective one of the first central regions and several second peripheral regions being each opposite to a respective one of the several first peripheral regions and enclosing a respective one of the second central regions, and wherein at least one of the first peripheral regions, the second peripheral regions and intermediate regions between the first and second peripheral regions is structured and wherein the ratio of a) the sum of the areas of the emission surfaces of the light emission units to b) the area of the first surface or the second surface of the outcoupling unit is smaller than 0.5. At least two of the light emission units can be adapted to emit light having different colors. This further increases the versatility in producing a desired illumination.

It is preferred that the lighting apparatus comprises a reflection element, which is provided on a part of a total surface of the outcoupling unit for reflecting light, which has left the outcoupling unit, back into the outcoupling unit, wherein the total surface is formed by the first and second surfaces and side surfaces connecting the first and second surfaces. For example, the reflection element can be provided on the first surface and the side surfaces such that the light leaves the lighting apparatus through the second surface substantially in the main emission direction. The reflection element prevents the loss of radiation in unwanted directions, thereby further increasing the extraction efficiency. Moreover, depending on the distribution of the reflection element on the total surface of the outcoupling unit, desired illumination effects can be created.

It is further preferred that a gap is present between the reflection element and at least a part of the total surface. The gap between the reflection element and the total surface allows the light within the outcoupling unit to be totally reflected, if the respective light ray meets the inner surface of the outcoupling unit in the corresponding angle. Since the efficiency of total reflection is generally larger than a reflection at the reflection element, losses of light can be reduced, thereby further increasing the efficiency of extracting light out of the lighting apparatus.

The reflection element has a reflectance being preferentially larger than 80 percent, further preferred larger than 90 percent and even further preferred larger than 95 percent. In an embodiment, the reflection element has a reflectance, in particular, a diffuse reflectance, of about 98 percent. The reflection element can be made of, for example, Alanod Miro Silver.

In a further aspect of the present invention a lighting system is presented, which comprises a group of lighting apparatuses as defined in claim 1. For example, rectangular luminaires can be arranged such that they form a two-dimensional array of luminaires.

In a further aspect of the present invention a production method for producing a lighting apparatus is presented, wherein the production method comprises:
providing a light emission unit for emitting light from an emission surface in a main emission direction,
providing an outcoupling unit for coupling the light out of the light emission unit, wherein the outcoupling unit comprises:
   a first surface having a first central region and a first peripheral region enclosing the first central region,
   a second surface being opposite to the first surface, the second surface having a second central region, which is opposite to the first central region, and a second peripheral region, which is opposite to the first peripheral region and which encloses the second central region, wherein at least one of the first peripheral region, the second peripheral region and an intermediate region between the first and second peripheral regions is structured and wherein the ratio of a) the area of the emission surface of the light emission unit to b) the area of the first surface or the second surface of the outcoupling unit is smaller than 0.5,
optically coupling the emission surface of the light emission unit and the first central region of the first surface.

It shall be understood that the lighting apparatus of claim 1, the lighting system of claim 14 and the production method of claim 15 have similar and/or identical preferred embodiments as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the drawings:

FIG. 1 shows schematically and exemplarily a cross sectional view of an embodiment of a lighting apparatus,

FIG. 2 shows schematically and exemplarily a view of the bottom surface of the embodiment of the lighting apparatus shown in FIG. 1,

FIG. 3 shows schematically and exemplarily a view of a bottom surface of another embodiment of a lighting apparatus,

FIGS. 4 and 5 show schematically and exemplarily embodiments of a lighting system comprising a group of lighting apparatuses,

FIG. 6 shows schematically and exemplarily a view of a bottom surface of another embodiment of a lighting apparatus,

FIG. 7 shows schematically and exemplarily a cross sectional view of the embodiment of the lighting apparatus shown in FIG. 6 along the line A-A,

FIG. 8 shows a flowchart exemplarily illustrating an embodiment of a production method for producing a lighting apparatus, and

FIG. 9 shows schematically and exemplarily a further embodiment of a lighting apparatus.

### DETAILED DESCRIPTION OF EMBODIMENTS

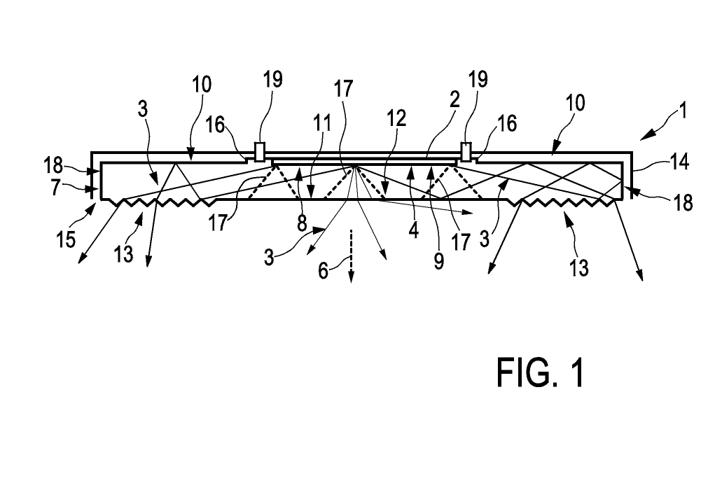

FIG. 1 shows schematically and exemplarily an embodiment of a lighting apparatus 1 comprising a light emission unit 2 and an outcoupling unit 7. The light emission unit 2 is adapted to emit light 3 from an emission surface 4 in a main emission direction 6. The outcoupling unit 7 is adapted to couple the light 3 out of the light emission unit 2 and comprises two opposing surfaces, a first surface 8 and a second surface 11.

The surface 8 has a first central region 9 optically coupled to the emission surface 4 of the light emission unit 2 and a first peripheral region 10 enclosing the first central region line. The second surface 11 has a second central region 12, which is opposite to the first central region 9, and a second peripheral region 13, which is opposite to the first peripheral region 10 and which encloses the second central region 12. The second peripheral region 13 is structured. The ratio of a) the area of the emission surface 4 of the light emission unit 2 to b) the area of the first surface 8 or the second surface 11 of the outcoupling unit 7 is smaller than 0.5.

The first and second surfaces 8, 11 are parallel to each other and perpendicular to the main emission direction 6. The outcoupling unit 7 is a light-guide plate made of glass, PMMA or another transparent material, wherein the first and second surfaces 8, 11 are formed by the two opposing main sides of the light-guide plate.

The main emission direction 6 is perpendicular to the emission surface 4 which can be defined as being the average direction in which the light 3 emitted by the light emission unit 2 leaves the light emission unit 2.

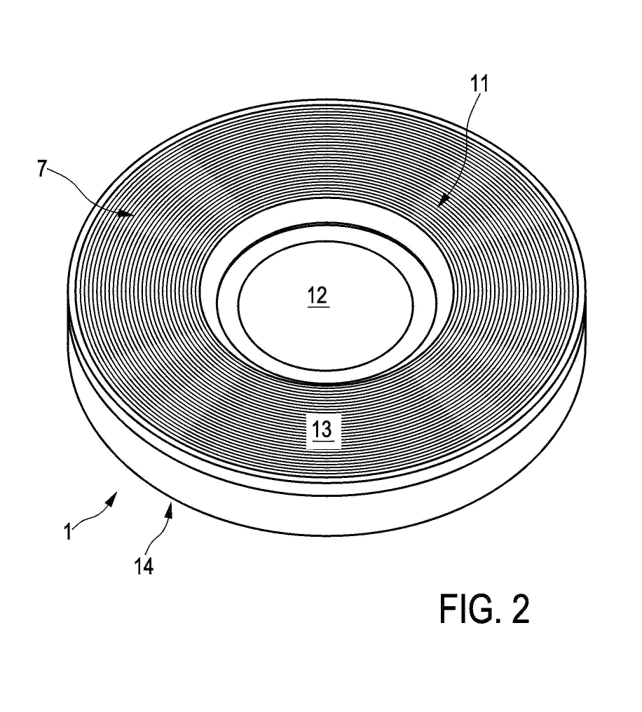

FIG. 1 shows schematically and exemplarily a cross sectional view through the lighting apparatus 1, whereas FIG. 2 shows schematically and exemplarily a view of the bottom of the lighting apparatus 1 shown in FIG. 1. In this embodiment, the first and second central regions 9, 12 are circular and the corresponding first and second peripheral regions 10, 13 have a ring-like shape. In other embodiments, the first and/or second central regions can also have another shape. Moreover, the enclosing respective first and second peripheral regions can be shaped in accordance with the first and second central regions, respectively, or they can have another shape.

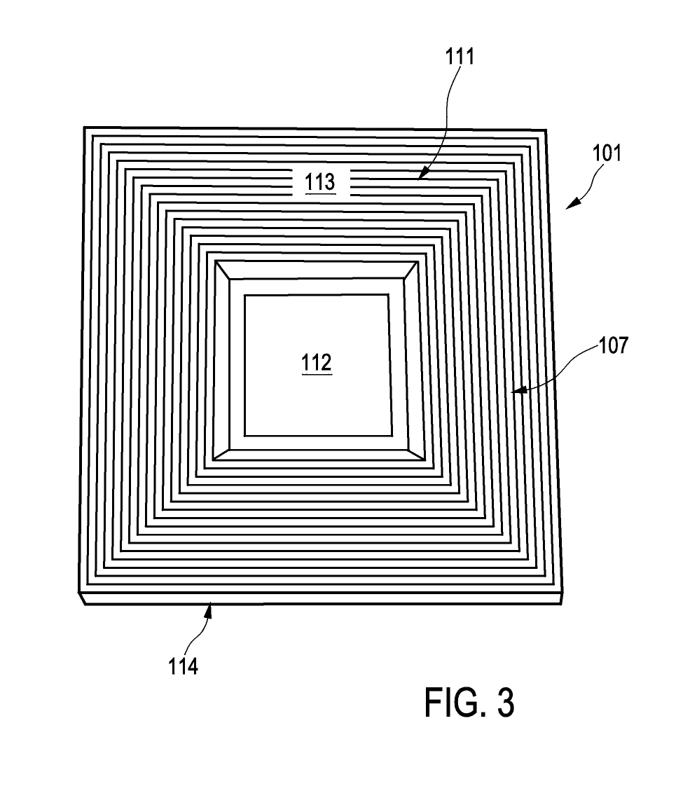

FIG. 3 shows schematically and exemplarily a view of a bottom side of another embodiment of a lighting apparatus. The lighting apparatus 101 shown in FIG. 3 is similar to the lighting apparatus 1 shown in FIGS. 1 and 2, except for the shapes of the first and second surfaces, of the first and second central regions and of the first and second peripheral regions. In particular, the lighting apparatus 101 shown in FIG. 3 comprises a second surface 111 with a second peripheral region 113 and a second central region 112. FIG. 3 shows, considering the orientation shown in FIG. 1, the bottom part of the lighting apparatus 101. Thus, in FIG. 3 the bottom side of the outcoupling unit 107 can be seen in FIG. 3.

The lighting apparatuses 1 and 101 shown in FIGS. 1, 2 and 3 are preferentially luminaires.

Referring again to FIG. 1, the light emission unit is an OLED, in particular, a bottom emitting OLED, wherein the emission surface 4, through which the light leaves the OLED 2, is located at the bottom of the OLED in the orientation shown in FIG. 1. In another embodiment, the OLED can also be top emitting OLED having an emission surface, through which the light leaves the OLED, at the top of the OLED. In this case, the outcoupling unit would be arranged on the top of the OLED.

The OLED 2 is preferentially a known OLED having a substrate, on which several organic light emitting layers, an anode and a cathode are arranged. In this embodiment, the OLED 2 is optically coupled to the first central region 9 of the first surface 8 by attaching the substrate of the OLED 2 optically to the first central region 9. In another embodiment, the substrate and the outcoupling unit can be formed as a single integrated element made of, for example, glass, PMMA or another transparent material.

In this embodiment, on the top side of the outcoupling unit 7 a ring-shaped protrusion 16 is present, in order to prevent a movement of the OLED 2 on the outcoupling unit 7. In another embodiment, the protrusion 16 may not be present or may have another shape, in particular, in correspondence with the respective shape of the light emission unit. If a protrusion for holding the light emission unit is not present on the upper outer surface of the outcoupling unit, the light emission unit can be held in place by using an adhesive, which is transparent and adheres the light emission unit to the planar first surface such that the emission surface of the light emission unit is optically coupled to the first central region of the first surface.

The outcoupling unit 7 has a thickness, i.e. a dimension in the main emission direction 6, which is larger than a fifth of the length of a shortest line connecting two opposing parts of the perimeter of the emission surface 4 and traversing the center of the emission surface 4. In this embodiment, the emission surface 4 is circular and the length of the shortest line connecting two opposing parts of the perimeter of the circular emission surface 4 and traversing the center of the circular emission surface 4 is the diameter of the emission surface 4. Thus, the thickness of the outcoupling unit being, in this embodiment, a light-guide plate is, at least at the position at which the light emission unit 2 is arranged, larger than a fifth of the diameter and further preferred larger than a quarter of the diameter of the emission surface 4. The thickness of the outcoupling unit 7 is, for example, in the range of about 1.5 to 2.0 cm. Moreover, the thickness of the outcoupling unit 7 is preferentially smaller than a half of the diameter of the emission surface 4.

The second central region 12 is larger than the first central region 9. In particular, the dimensions of the outcoupling unit 7 define an outcoupling angular range defined by total internal reflection, wherein rays of the emitted light enclosing an emission angle with the main emission direction 6, which is outside of the outcoupling angular range, would be totally reflected on the inner second surface 11, if the inner second surface 11 would be planar, wherein the second central region 12 is planar and dimensioned such that all rays within the outcoupling angular range meet the second central region 12. In other words, the outcoupling angular range defines an outcoupling cone or escape cone 17, wherein the second central region 12 is dimensioned such that all rays within the outcoupling cone 17 meet the planar second central region 12, whereas rays outside of the outcoupling cone 17 are propagated to the first and second peripheral regions 10, 13, where these rays may leave the outcoupling unit 7 after being scattered at the structured second peripheral region 13. In this embodiment, the first and second surfaces have the same size such that, since the first central region is smaller than the second central region, the first peripheral region is larger than the second peripheral region.

The structuring in the second peripheral region 13 is provided by refractive and/or scattering structures. The structures can be, for example, 1 mm or smaller. In particular, they can be in the range of 10 to 100 μm. They can be microstructures, in particular, micro lenses. The structures can also be, for example, spherical or prismatic structures. They can be formed as indentations in the outcoupling unit. The structure can be a regular structure or an irregular structure which may be produced by sandblasting.

The lighting apparatus 1 further comprises a reflection element 14, which is provided on a part of the total surface of the outcoupling unit 7 for reflecting light, which has left the outcoupling unit 7, back into the outcoupling unit 7, wherein the total surface is formed by the first and second surfaces and a side surface 18 connecting the first and second surfaces. In this embodiment, the reflection element 14 covers the side surface 18 and the first surface 8 of the outcoupling unit 7. The reflection element 14 is attached to the outcoupling unit 7 by using attaching means 19 like an adhesive or screws such that a gap 15 is present between the reflection element 14 and the outer surface of the outcoupling unit 7. The lighting apparatus 101 shown in FIG. 3 also comprises a reflection element denoted by reference number 114.

The reflection element has a reflectance being preferentially larger than 80 percent, further preferred larger than 90 percent and even further preferred larger than 95 percent. In this embodiment, the reflection element has a reflectance of about 98 percent and is made of Alanod Miro Silver.

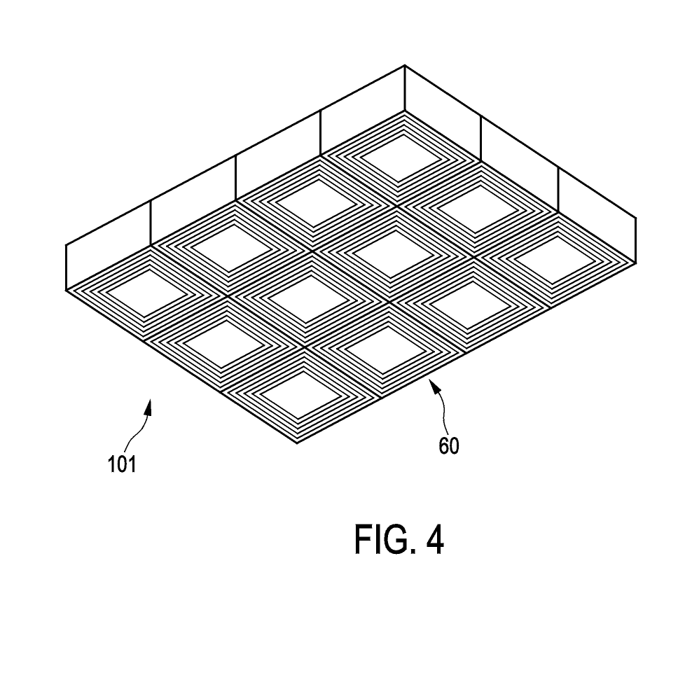

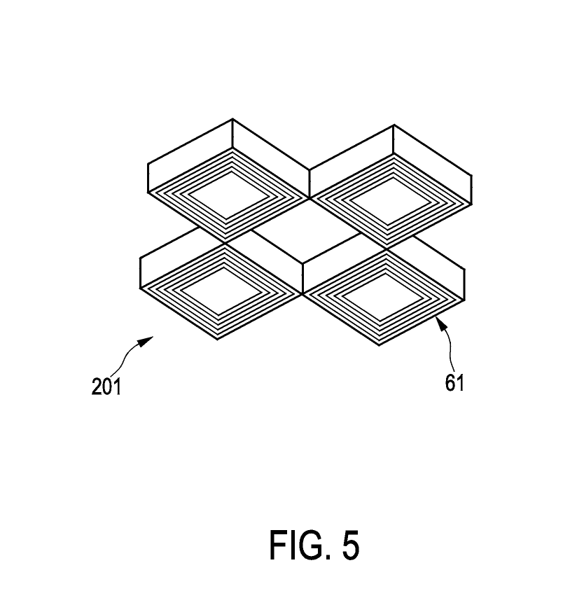

FIG. 4 shows schematically and exemplarily an embodiment of a lighting system 60 comprising a group of the lighting apparatuses 101 shown in FIG. 3. In particular, the lighting system 60 comprises a two-dimensional array of the lighting apparatuses 101. FIG. 5 shows schematically and exemplarily a further embodiment of a lighting system. The lighting system 61 shown in FIG. 5 also comprises a group of lighting apparatuses 101, but in another configuration.

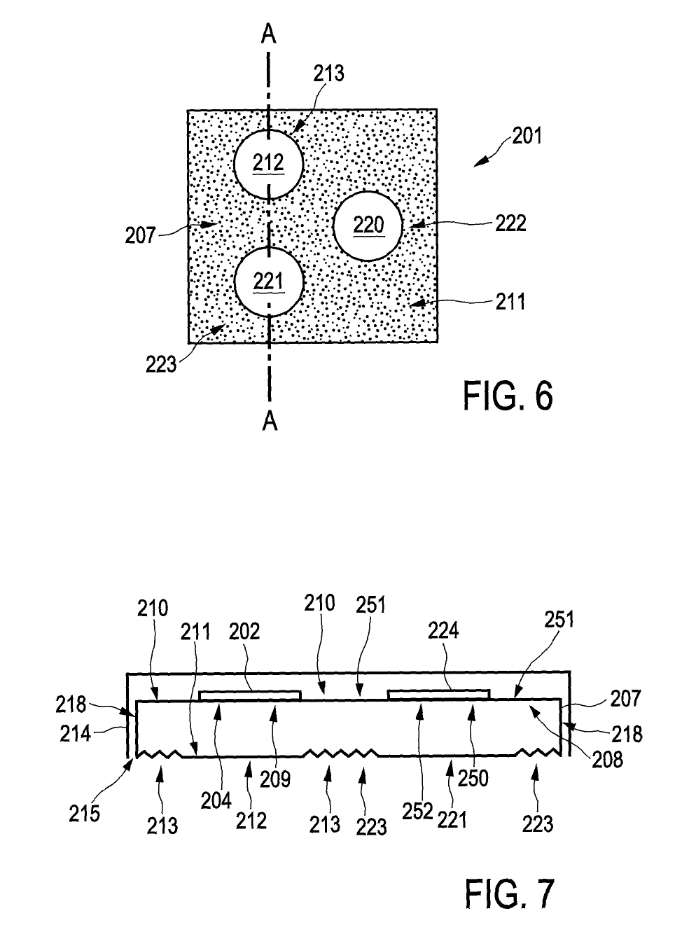

FIGS. 6 and 7 show schematically and exemplarily a further embodiment of a lighting apparatus. FIG. 6 shows schematically a view of the bottom of the outcoupling unit 207 of the lighting apparatus 201 and FIG. 7 shows a cross sectional view along the line A-A shown in FIG. 6.

The lighting apparatus 201 comprises several light emission units with several emission surfaces emitting light in the main emission direction. The outcoupling unit 207 comprises a first surface 208 with several first central regions optically coupled to the several emission surfaces and several first peripheral regions enclosing the first central regions. In this embodiment, the lighting apparatus 201 comprises three light emission units with three emission surfaces, wherein three first central regions are present on the first surface for optically coupling the three emission surfaces. FIG. 7 shows two of these light emission units denoted by reference numbers 202 and 224, two corresponding emission surfaces 204, 252 and two corresponding first central regions 209, 250. The first peripheral regions are denoted by reference numbers 210, 251 in FIG. 7.

The lighting apparatus 201 further comprises a second surface 211 with several second central regions 212, 220, 221 being each opposite to a respective one of the first central regions and several second peripheral regions 213, 222, 223 being each opposite to the respective one of the several first peripheral regions and enclosing a respective one of the second central regions 212, 220, 221. The second peripheral regions 213, 222, 223 are structured, for example, by sandblasting or another structuring technique. The second peripheral regions 213, 222, 223 merge into each other and form a single structured region which encloses the planar second central regions 212, 220, 221. Correspondingly, the first peripheral regions also merge into each other and form a single peripheral region on the first surface 208. The ratio of a) the sum of the areas of the emission surfaces of the light emission units to b) the area of the first surface 208 and, thus, of the second surface 211 of the outcoupling unit 207 is smaller than 0.5. The different light emission units of the lighting apparatus 201 can be adapted to emit light having the same color or light having different colors.

The lighting apparatus 201 further comprises a reflection element 214 covering a side surface 218 and the first surface 208 of the outcoupling unit 207. A gap 215 is present between the outcoupling unit 207 and the reflection element 214 for allowing total internal reflection, if the light meets the inner first surface 208 or the inner side surface 218 with a corresponding total reflection angle.

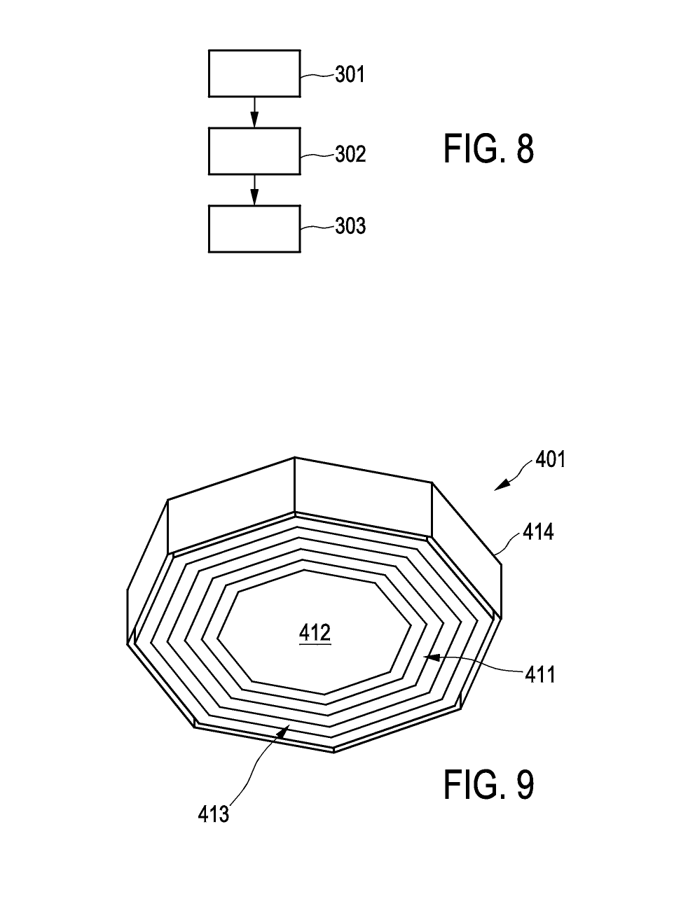

FIG. 8 shows a flowchart exemplarily illustrating an embodiment of a production method for producing a lighting apparatus.

In step 301, a light emission unit 2 for emitting light from an emission surface 4 in a main emission direction 6 is provided. In particular, an OLED is provided, which has a substrate, for example, a glass substrate, wherein organic light emitting layers, an anode and a cathode are arranged on the substrate.

In step 302, an outcoupling unit for coupling the light out of the light emission unit, in particular, for coupling the light out of the substrate of the OLED, is provided. The outcoupling unit comprises a first surface having a first central region and a first peripheral region enclosing the first central region, and a second surface being opposite to the first surface. The second surface has a second central region, which is opposite to the first central region, and a second peripheral region, which is opposite to the first peripheral region and which encloses the second central region. At least one of first peripheral region, the second peripheral region and an intermediate region between the first and second peripheral regions is structured. The outcoupling unit is provided such that the ratio of a) the area of the emission surface of the light emission unit to b) the area of the first surface or the second surface of the outcoupling unit is smaller than 0.5. For instance, a transparent plate made of, for example, glass or PMMA can be configured such that the transparent plate has two opposing main surfaces forming the first and second surfaces, wherein the two opposing main surfaces are dimensioned such that the ratio of a) the area of the emission surface of the light emission unit to b) the area of one of the main surfaces of the transparent plate is smaller than 0.5. The structure can then be provided by, for example, sandblasting or another technique for forming a structure in the transparent plate.

In step 303, the emission surface of the light emission unit and the first central region of the first surface are optically coupled. For instance, an adhesive can be used for adhering the light emission unit to the first central region of the first surface such that they are optically coupled.

An OLED consists generally of thin organic electroluminescent layers embedded between two electrodes, wherein at least one of which is transparent. The OLED is preferentially a bottom emitting OLED in which the OLED stack is deposited on a transparent substrate and light is emitted through the substrate into air. The amount of light extracted into air is limited by total internal reflection at the substrate/air interface, i.e. only light rays inside the escape cone, which has typically a half opening of 42 degrees for glass substrates, are transmitted into air, whereas light rays outside the escape cone are caught and lost by total internal reflection at the substrate/air interface inside the substrate. For this reason generally only about 50 percent of the light in the substrate is extracted into air. The above described outcoupling unit increases the extraction of light out of the substrate, has a relatively small thickness and provides a relatively large emission area formed by the second central and peripheral regions of the second surface of the outcoupling unit.

The outcoupling unit can be regarded as being a flat macroextractor in the form of a light-guide plate as shown, for example, in FIG. 1. The basic idea is to optically attach the OLED, which can have any shape, for instance, which can be circular or rectangular, to the central part of the light-guide plate and to leave the surface of the light-guide plate extending opposite of the OLED unstructured so that the light emanating from the OLED inside the escape cone can transverse the light-guide plate without impediment. Light rays outside the escape cone are propagated to the outer parts, i.e. the peripheral regions, of the light-guide plate. To overcome total internal reflection the surface of the outer part of the light-guide plate, for instance, the bottom surface and/or the top surface, can be endowed with microrefractive or scattering structures to extract the light. To ensure that light escapes only through a desired part, for instance, the bottom part of the light-guide plate, the light-guide plate can be enclosed by a highly reflecting material such as Alanod Miro Silver which has a reflectance of about 98 percent. The reflector, i.e. the reflection element, can cover the top and side walls or only a top part as desired. By using such an outcoupling unit more than 90 percent of the light in the OLED substrate can be extracted into air, wherein the extracted light is spread over the second surface of the light-guide plate. The second surface of the light-guide plate can be made as large as desired, wherein the ratio of a) the area of the emission surface of the light emission unit to b) the area of the second surface of the light-guide plate is preferentially smaller than 0.5. Moreover, the light-guide plate can be relatively thin. For instance, it can be about a quarter of the diameter of the OLED. This relatively thin light-guide plate can be realized, while still providing large extraction efficiency, because the rays outside of the escape cone subtend a large angle with the normal of the light-guide plate, so that only a small percentage of them will hit the OLED again and will get absorbed. The outcoupling unit can be, for example, circular with a diameter of about 170 mm and a thickness of about 20 mm, wherein the emission surface can also be circular and have a diameter of, for instance, 60 mm. Or, it can be quadratic having a size of about 200×200 mm and a thickness of about 20 mm, wherein the emission surface can also be quadratic with a side length of, for instance, 50 mm.

The lighting apparatus and the lighting system can be applied in general and/or decorative lighting, wherein individual lighting apparatuses, i.e. individual luminaires, can be used as exemplarily shown in FIGS. 1 to 3, or wherein luminaires can be juxtaposed as exemplarily shown in FIGS. 4 and 5. If the light emission unit is an OLED, depending on the OLED interesting color effects can be realized due to the dependence of the color on emission angle in the substrate. Large light-guide plates may carry several OLEDs, which possibly emit different colors, with extraction structures between the areas covered by the OLEDs, in order to give interesting visual and coloration effects.

The lighting apparatus, i.e. the luminaire, can have arbitrary polygonal shapes, for example, it can have a square, rectangular, octagonal, round et cetera shape. FIG. 9 shows schematically and exemplarily a lighting apparatus 401 having an octagonal shape. The structure of the lighting apparatus 401 is similar to the lighting apparatus described above with reference to FIG. 1, wherein the second surface 411 with the second central region 412 and the second peripheral region 413 is octagonal. Also the lighting apparatus 401 comprises a reflection element 414.

Although in the above described embodiments the light emission unit is an OLED, in another embodiment the light emission unit can also be another light source, for example, another planar light source having a light emission surface.

Although in above described embodiments the reflection element covers the first surface and optionally also the side surface of the outcoupling unit, the reflection element can also cover other parts of the outer surfaces of the outcoupling unit, in order to provide a desired illumination. For instance, in an embodiment the second peripheral region and the side surfaces can be covered by the reflection element, whereas the first peripheral region may not be covered by the reflection element, in order to allow the light to leave the outcoupling unit through the first surface and through the second surface of the outcoupling unit.

Although in above described embodiments the second peripheral region is structured, in other embodiment in addition or alternatively at least one of the first peripheral region and the intermediate region between the first and second peripheral regions can be structured. For instance, in the volume between the first and second peripheral regions scattering elements or structures with different refractive indices can be present. Moreover, the first and second peripheral regions can both be structured, wherein the structures on the first peripheral region can be different to the structures on the second peripheral region.

If a peripheral region is not structured, the peripheral region and the corresponding central region are preferentially planar such that they together form a planar surface. For instance, if the first peripheral region is not structured, the first surface can be a planar surface comprising the first central region and the first peripheral region, wherein the first peripheral region is defined by being opposite to the second peripheral region, which in this case is preferentially structured, and the first central region is defined by being opposite to the second central region, which in this case is preferentially planar.

Although the production method described above with reference to the flowchart shown in FIG. 8 comprises a certain sequence of steps, the sequence of steps can also be different. For example, the step of providing an outcoupling unit can be performed before or simultaneously with the step of providing a light emission unit.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

The invention relates to a lighting apparatus comprising a light emission unit for emitting light from an emission surface in a main emission direction, and an outcoupling unit for coupling the light out of the light emission unit. The outcoupling unit comprises a first surface having a first central region optically coupled to the emission surface and a first peripheral region enclosing the first central region, and a second surface opposite to the first surface. The peripheral regions can be structured, wherein the ratio of a) the area of the emission surface to b) the area of the first surface or the second surface is smaller than 0.5. This configuration can significantly decrease the likelihood of reabsorption of light by the emission surface, thereby increasing the efficiency of extracting light out of the lighting apparatus.

1. A lighting apparatus comprising:
a light emission unit for emitting light from an emission surface in a main emission direction the light emission unit being an organic light emitting diode having a substrate,
an outcoupling unit for coupling the light out of the substrate of the organic light emitting diode
wherein the outcoupling unit is a guide plate comprising:
a first surface having a first central region optically coupled to the emission surface of the light emission unit and a first peripheral region enclosing the first central region
a second surface having a second central region, which is opposite to the first central region, and a second peripheral region, which is opposite to the first peripheral region and which encloses the second central region,
wherein the first surface and the second surface are opposite and substantially parallel to each other, and substantially perpendicular to the main emission direction,
wherein the second central region is unstructured,
wherein at least one of the first peripheral region, the second peripheral region and an intermediate region between the first and second peripheral regions is structured, and
wherein the ratio of a) the area of the emission surface of the light emission unit to b) the area of the first surface or the second surface of the outcoupling unit is smaller than 0.5.

2. (canceled)

3. The lighting apparatus as defined in claim 1, wherein a dimension of the outcoupling unit in the main emission direction is larger than a fifth of the length of a shortest line connecting two opposing parts of the perimeter of the emission surface and traversing the center of the emission surface.

4. The lighting apparatus as defined in claim 1, wherein a dimension of the outcoupling unit in the main emission direction is smaller than a half of the length of a shortest line connecting two opposing parts of the perimeter of the emission surface and traversing the center of the emission surface.

5. The lighting apparatus as defined in claim 1, wherein the second central region is larger than the first central region.

6. The lighting apparatus as defined in claim 1, wherein the dimensions of the outcoupling unit define an outcoupling angular range defined by total internal reflection, wherein rays of the emitted light enclosing an emission angle with the main emission direction, which is outside of the outcoupling angular range, would be totally reflected on the inner second surface, if the inner second surface would be planar, wherein the second central region is planar and dimensioned such that all rays within the outcoupling angular range meet the second central region.

7. The lighting apparatus as defined in claim 1, wherein one of the first peripheral region and the second peripheral region is planar and the other of the first peripheral region and the second peripheral region is structured.

8. The lighting apparatus as defined in claim 1, wherein the first peripheral region and the second peripheral region are structured.

9. The lighting apparatus as defined in claim 8, wherein the first and second peripheral regions are structured differently.

10. The lighting apparatus as defined in claim 1, wherein the structuring is provided by at least one of refractive and scattering structures.

11. The lighting apparatus as defined in claim 1, wherein
the lighting apparatus comprises several light emission units with several emission surfaces emitting light in the main emission direction,
the first surface comprises several first central regions optically coupled to the several emission surfaces and several first peripheral regions enclosing the first central regions,
the second surface comprises several second central regions being each opposite to a respective one of the first central regions and several second peripheral regions being each opposite to a respective one of the several first peripheral regions and enclosing a respective one of the second central regions, wherein at least one of the first peripheral regions, the second peripheral regions and intermediate regions between the first and second peripheral regions is structured and wherein the ratio of a) the sum of the areas of the emission surfaces of the light emission units to b) the area of the first surface or the second surface of the outcoupling unit is smaller than 0.5.

12. The lighting apparatus as defined in claim 1, wherein the lighting apparatus comprises a reflection element, which is provided on a part of a total surface of the outcoupling unit for reflecting light, which has left the outcoupling unit, back into the outcoupling unit, wherein the total surface is formed by the first and second surfaces and side surfaces connecting the first and second surfaces.

13. The lighting apparatus as defined in claim 12, wherein a gap is present between the reflection element and at least a part of the total surface.

14. A lighting system comprising a group of lighting apparatuses as defined in claim 1.

15. A production method for producing a lighting apparatus, the production method comprising:
providing a light emission unit for emitting light from an emission surface in a main emission direction, the light emission unit being an organic light emitting diode having a substrate,
providing an outcoupling unit for coupling the light out of the substrate of the organic light emitting diode, wherein the outcoupling unit is a light-guide plate comprising:
a first surface having a first central region and a first peripheral region enclosing the first central region,
a second surface having a second central region, which is opposite to the first central region, and a second peripheral region, which is opposite to the first peripheral region and which encloses the second central region, wherein the first surface and the second surface are opposite and substantially parallel each other, and substantially perpendicular to the main emission direction, where the second central region is unstructured, wherein at least one of the first peripheral region, the second peripheral region and an intermediate region between the first and second peripheral regions is structured and wherein the ratio of a) the area of the emission surface of the light emission unit to b) the area of the first surface or the second surface of the outcoupling unit is smaller than 0.5,
optically coupling the emission surface of the light emission unit and the first central region of the first surface.
